(19) United States
(12) Patent Application Publication
(10) Pub. No.: US 2006/0094355 A1
(43) Pub. Date: May 4, 2006

(54) Bluetooth device for hands-free conversation and voice dialing on a bluetooth cellular phone

(76) Inventor: Chung-Hung Lin, Syuojia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/976,753

(22) Filed: Nov. 1, 2004

(51) Int. Cl. H04B 5/00

(52) U.S. Cl. 455/41.1

(57) ABSTRACT

A bluetooth device includes a controller, a bluetooth module for wireless transmission together with a bluetooth cellular phone, a microphone, a speaker, a connector for connection to a keyboard, buttons for operating the controller with, and a memory; a database is built in the memory by means of inputting phone numbers of people to contact through a keyboard plus by means of inputting vocal data, which represent respective ones of the people to contact, through both the microphone and the controller; thus when a user wants to make a call to a person with a bluetooth cellular phone, he can dial in a hands-free way by means of making vocal signals to the microphone.

### BACKGROUND OF THE INVENTION

1. Field of the Invention

The present invention relates to a bluetooth device for use with a bluetooth cellular phone, more particularly one, which includes a controller, a speaker, a microphone, and a bluetooth module for allowing hands-free conversation and voice dialing on a bluetooth cellular phone, and which have a memory for storing therein phone numbers of people to contact and vocal data representing respective ones of the people.

2. Brief Description of the Prior Art

Cellular phones provide people with convenience, allowing people to have phone conversation when they are driving or riding in a vehicle and from any location where signal transmission is OK between the phones and the base stations.

Many kinds of cellular phone accessories are developed for providing people with more convenience. Among the various accessories, headset, built-in hands-free set and speakerphone are very important and popular, which allow hands-free conversation on a cellular phone, preventing the risk of having a car accident from increasing. With the help of a hands-free set, one won't have to pick up the cell phone to take a call or hold the cell phone to have conversation while driving, therefore he/she can drive more safely; voices are passed on through the microphone and the speaker of the hands-free set. In addition, because older cars don't have built-in hands-free set, plug-in hands-free sets are developed that can be plugged into cigarette lighter sockets of cars.

However, none of the above hands-free devices allow people to dial in a hands-free way. Consequently, one still have to dial in the conventional way while driving, and the risk of having an accident increases, with the driver fumbling with the cell phone and looking at the cell phone instead of the road.

### SUMMARY OF THE INVENTION

It is a main object of the invention to provide a bluetooth device for hands-free conversation and voice dialing on a bluetooth cellular phone to overcome the above disadvantage.

The bluetooth device of the present invention includes a controller, a bluetooth module for wireless transmission together with a bluetooth cellular phone, a microphone, a speaker, a connector for connection to a keyboard, buttons for operating the controller with, and a memory. A database is first built in the memory by means of inputting phone numbers of people to contact with the help of the keyboard plus by means of inputting vocal data, which represent respective ones of the people, through both the microphone and the controller. Thus, when the user wants to make a call to a person with a bluetooth cellular phone, he can dial in a hands-free way by means of making voices to the microphone.

### BRIEF DESCRIPTION OF THE DRAWINGS

The present invention will be better understood by referring to the accompanying drawings, wherein:

FIG. 1 is a circuit block diagram of the first embodiment of a bluetooth device for voice dialing on a bluetooth cellular phone,

FIG. 2 is a perspective view of the bluetooth device of the present invention, and

FIG. 3 is a circuit block diagram of the second embodiment of a bluetooth device in the present invention.

### DETAILED DESCRIPTION OF THE PREFERRED EMBODIMENTS

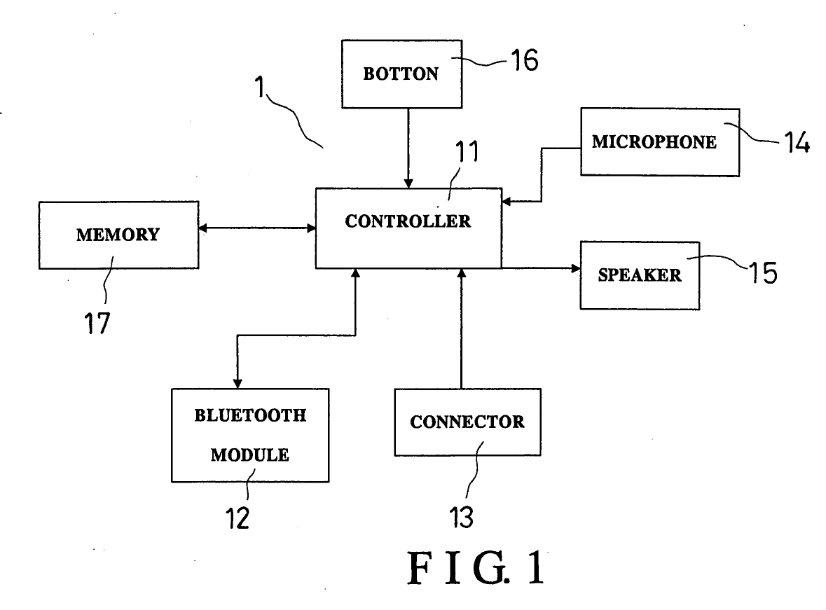

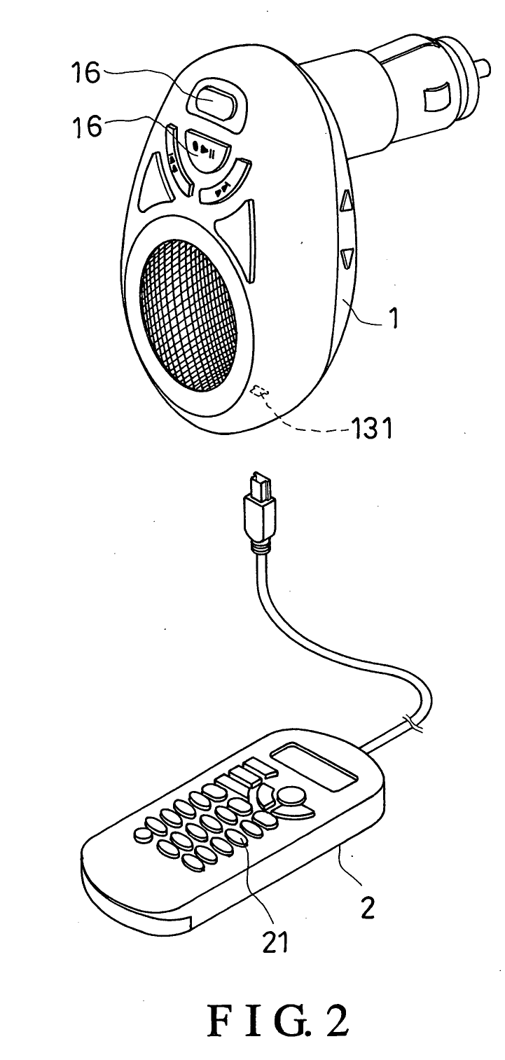

Referring to FIGS. 1 and 2, a first embodiment of a bluetooth device for hands-free conversation and voice dialing on a bluetooth cellular phone includes a housing 1, a controller 11, a bluetooth module 12, a connector 13, a microphone 14, a speaker 15, several buttons 16, and a memory 17.

The bluetooth module 12 is electrically connected to the controller 11 for wireless transmission of signals to and wireless reception of signals from a bluetooth cellular phone.

The connector 13 is on an outer side of the housing 1 and electrically connected to the controller 11, and it can be a terminal 131 for connection with a wire or an infrared transmission unit.

The microphone 14 and the speaker 15 are electrically connected to the controller 11.

The buttons 16 are fitted on an outer side of the housing 1 and electrically connected to the controller 11 for operating the present bluetooth device with. And, the memory 17 is electrically connected to the controller 11.

To use the present bluetooth device with a bluetooth cellular phone, one should first connect the connector 11 to a keyboard 2, and then build a database in the memory 17 by means of inputting phone numbers of people to contact with the help of buttons 21 of the keyboard 2 as well as by means of inputting vocal data, which represent respective ones of the people to contact, through both the microphone 14 and the controller 11. Therefore, the database contains phone numbers and different vocal data. And, the present device is made in such a way that it can be plugged into a cigarette lighter socket of a car for power to be supplied thereto.

Afterwards, when the user wants to make a call to a person, he/she should make vocal signals representing that person to the microphone 14; thus, the controller 11 will find the corresponding phone number stored in the memory 17 according to the vocal signals, and the bluetooth module 12 will transmit signals to the bluetooth cellular phone, which will in turns make a call according to the corresponding telephone number. And, the user can have hands-free conversation with the person with the help of the phone and the present device, with voices being passed on through the speaker 15 and the microphone 14.

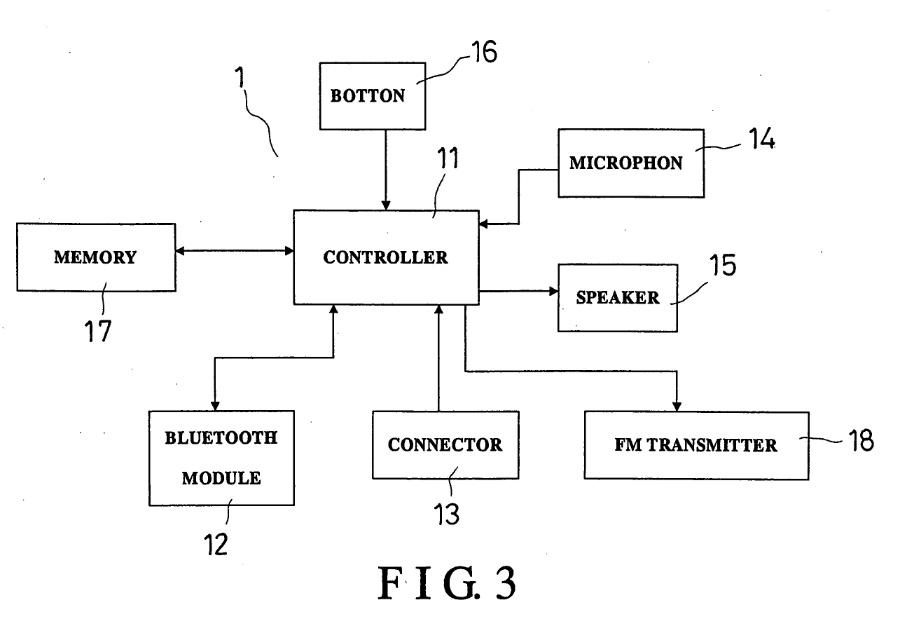

Referring to FIG. 3, a second embodiment of a bluetooth device for hands-free conversation and voice dialing with a cellular phone includes housing 1, controller 11, bluetooth module 12, connector 13, microphone 14, speaker 15, buttons 16, memory 17, and a FM (frequency modulation) transmitter 18 electrically connected to the controller 11. The memory 17 has digital musical data, e.g. MP3, stored therein. And, the FM transmitter 18 is used for transmitting the digital musical data to a radio of a car. Thus, after the user uses the buttons 16 to set the present device at the music playing mode, music can be played through the stereo system of the car.

From the above description, it can be understood that the bluetooth device of the present invention has the following advantages:

1. When used together with a bluetooth cellular phone, the bluetooth device allows the user to take a call and have conversation in hands-free way and allows the user to dial by means of voices instead. Consequently, the user can drive more safely, concentrating on the road rather than fumbling with the cellular phone.

2. With the FM transmitter and the memory, in which digital musical data are stored, the present device can work together with a car stereo system to play music.

What is claimed is:

1. A bluetooth device for hands-free conversation and voice dialing on a bluetooth cellular phone, comprising
a housing shaped in such a way as to be connectable with a cigarette lighter socket of a car;
a controller in the housing;
a bluetooth module electrically connected to the controller for wireless transmission of signals to and wireless reception of signals from a bluetooth cellular phone;
a microphone connected to the controller;
a speaker connected to the controller;
a connector connected to the controller for connection to a key-in device;
a plurality of buttons on the housing for operating the controller with; and
a memory connected to the controller;
a database being built in the memory by means of inputting phone numbers of people to contact through the keyboard as well as by means of inputting vocal data, which represent respective ones of the people to contact, through both the microphone and the controller;
whereby when a user wants to make a call to a person with a bluetooth cellular phone, he can dial in a hands-free way by means of making vocal signals to the microphone.

2. The bluetooth device as claimed in claim 1, wherein the connector is of a type that is used together with a wire.

3. The bluetooth device as claimed in claim 1, wherein the connector is an infrared transmission unit.

4. The bluetooth device as claimed in claim 1, wherein a FM transmitter is connected to the controller, and digital musical data are stored in the memory so that music can be played through a car stereo system.
